(19) United States
(12) Patent Application Publication
(10) Pub. No.: US 2011/0093847 A1
(43) Pub. Date: Apr. 21, 2011

(54) Application Hosting Service for Cloud Environments Using Dynamic Machine Images

(76) Inventor: Dharmesh R. Shah, San Jose, CA (US)

(21) Appl. No.: 12/579,565

(22) Filed: Oct. 15, 2009

(51) Int. Cl. G06F 9/455

(52) U.S. Cl. 718/1

(57) ABSTRACT

Systems, methods, and computer-readable storage media are disclosed for executing applications in a computing cloud. At least one computer in the cloud receives input from a client computer specifying a dynamic machine image (DMI) that includes a first program configured to dynamically deploy applications, and receives input from the client computer specifying one or more applications. The at least one computer deploys the specified DMI on one or more computers in the cloud in response to the input from the client computer specifying the DMI, thereby generating a corresponding virtual machine instance (VMI). The first program deploys at least a portion of each of the one or more requested applications to the VMI in response to the input from the client computer specifying the one or more applications, and the VMI executes at least one of the at least a portion of each of the one or more requested applications.

### BACKGROUND

1. Technical Field

This disclosure relates generally to cloud computing, and, more specifically, to application hosting for cloud computing using dynamic machine images.

2. Description of the Related Art

Cloud computing environments provide infrastructure as a service in the form of virtual machines. Cloud users can typically instantiate virtual machines in the cloud and run their applications inside the virtual machine instances (VMIs). To create a virtual machine instance, the cloud user typically needs a machine image (MI), which may be considered a packaged environment that includes all the necessary components to set up and boot the VMI. Application virtualization is a mature technology in the enterprise environment, focusing primarily on addressing application isolation, compatibility issues and reducing management/support costs, and virtual machine instances created in a cloud environment are generally disposable. Typically, a machine image contains operating system binaries, application programs, libraries and other configuration data. In some instances, cloud users create their own machine images and upload them onto the cloud. Alternatively, in some cases a catalog of machine images pre-configured with various supported operating systems and a few of the third-party applications pre-installed may be provided, e.g., by a cloud service provider. For example, these machine images may include standard distributions of Linux and common versions of the Windows™ OS, and so forth. While such machine images serve many common cases, it is impossible for a cloud service provider to publish a catalog of machine images that cover all possible combinations of operating systems and third-party applications. Thus, static, pre-configured machine images are inadequate for the service provider.

Additionally, cloud users who need any form of customization regarding virtual machines must generally create and maintain their own machine images. Once a virtual machine is shutdown, any customization applied on top of “standard or default” machine images is lost. Thus the only way to preserve a cloud user's customization has been to create the custom machine image and preserve the entire machine image. This creates problems for the cloud users too, in that any customized machine image that is uploaded onto the cloud results in recurring storage costs. Additionally, licensing issues may prevent a cloud user from pre-installing all applications in a single “one-size-fits-all” machine image, and so the cloud users may end-up creating and maintaining multiple machine images in the cloud. Thus, there is a resulting proliferation of machine images customized for a wide variety of combinations of operating systems and applications that require commensurate storage, which is expensive. These problems derive from the fact that the machine images are statically configured.

Accordingly, improvements in the field would be desirable.

### SUMMARY

Embodiments are presented of a system and method for application hosting in a computing cloud using dynamic machine images.

One set of embodiments includes a computer-implemented method for executing applications in a computing cloud. The method may include utilizing at least one computer in a computing cloud to perform the following:

Input may be received from a client computer (e.g., from a user) specifying a dynamic machine image (DMI). The DMI may include (e.g., may store or include a reference to) a software program (also referred to as a “first program”) which is configured to dynamically deploy applications. The first program may be configured as an agent software program and may be referred to as a dynamic application deployment (DAD) agent. Input may also be received from the client computer specifying one or more applications. In some embodiments, the user may specify the DMI and the application(s) by specifying a virtual machine instance (VMI) configuration. In this instance, the VMI configuration may be received from the client computer, retrieved from a storage device, or retrieved from a repository included in or coupled to the computing cloud.

The specified DMI may then be deployed on one or more computers in the computing cloud in response to the received input, thereby generating a corresponding virtual machine instance (VMI). For example, the first program may deploy (or cause deployment of) at least a portion of each of the requested application(s) to the VMI. In deploying the requested application(s), the first program may request the application(s) from an application delivery service (which may be comprised in or coupled to the computing cloud) or may retrieve the application(s) directly from a storage device included in or coupled to the computing cloud. The application(s) may be stored in and retrieved from an application repository. The VMI may then execute at least one of the at least a portion of each of the one or more requested applications.

In some embodiments, input may be subsequently received from the client computer specifying at least one of the application(s) to be removed from the VMI. The VMI may then be dynamically modified in response to the received input by uninstalling the specified application from the VMI. Alternatively, or in addition, input may be received from the client computer specifying at least one additional application to be deployed to the VMI. The VMI may be dynamically modified in response to the received input by deploying at least a portion of the additional application to the VMI.

In some embodiments, the at least one computer in the computing cloud may operate to save a VMI configuration for the VMI in response to input from the client computer, where the VMI configuration specifies the DMI and the one or more applications. The VMI configuration may be useable to deploy the specified DMI and deploy the at least a portion of each of the one or more requested applications to the VMI.

One set of embodiments includes a computer readable storage medium that may comprise program instructions for executing any of the various methods described above. Embodiments of the invention may also comprise at least one computer system that is configured to perform any of the various methods described above.

Thus in some embodiments the user specifies a DMI which does not include specific applications. Rather, the applications may be specified separately, and the first program, e.g., the agent software, may operate to retrieve and deploy (or otherwise invoke deployment of) the application(s) to the VMI. This provides a much more flexible application deployment mechanism for VMIs, and also greatly reduces storage requirements for VMIs in cloud computing environments.

### BRIEF DESCRIPTION OF THE DRAWINGS

A better understanding of the present invention can be obtained when the following detailed description of the preferred embodiment is considered in conjunction with the following drawings, in which:

FIG. 1 is a block diagram illustrating a network architecture according to one embodiment;

FIG. 2 is a block diagram illustrating a computer system according to one embodiment;

FIG. 3 is a block diagram illustrating one embodiment of a representative client computer system configured to communicate with a computing cloud;

FIG. 4 is a block diagram illustrating one embodiment of a virtual machine host system;

FIG. 5 is a block diagram illustrating one embodiment of a cloud management server;

FIG. 6 is a block diagram illustrating one embodiment of an application delivery server; and

FIG. 7 is a block diagram illustrating one embodiment of a repository; and

FIG. 8 is a flow diagram illustrating an embodiment of a method for application hosting in a computing cloud.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Terminology. The following paragraphs provide definitions and/or context for terms found in this disclosure (including the appended claims):

“Comprising.” This term is open-ended. As used in the appended claims and disclosure, this term does not foreclose additional elements, structure, or steps. Consider a claim that recites: “An apparatus comprising one or more processor units . . . . ” Such a claim does not foreclose the apparatus from including additional components (e.g., a network interface unit, graphics circuitry, etc.).

“Computer System.” This term has its ordinary and accepted meaning in the art, and includes one or more computing devices operating together and any software stored thereon. A computing device includes one or more processor units and a memory subsystem. A memory subsystem may store program instructions executable by the one or more processor units.

“Client system.” This term has its ordinary and accepted meaning in the art, which includes a computer system that requests services, data, etc. from a server system.

“Machine Image (MI).” An MI is a pre-built software package used for creating virtual machine instances. An MI typically contains all necessary files for the operating system, device drivers, libraries and pre-installed applications, etc.

“Virtual Machine Instance (VMI)”. This term refers to a deployed or implemented (instantiated) machine image.

“Dynamic Machine Image (DMI).” A DMI is a pre-built software package that, in addition to the usual contents of a typical or “standard” MI, comprises (e.g., contains or references) a software program that is configured to perform dynamic application deployment, e.g., is configured to dynamically deploy applications to a VMI.

“Virtualization Module.” A virtualization module, also known as a virtual machine monitor (VMM) or hypervisor, is software or firmware that allows multiple virtual machines to run on at least one host physical machine. Each instance of the virtual machine can run a different operating system. The operating system running inside a virtual machine instance is called a guest operating system. Hypervisors may be broadly classified into two categories:

Type-1 hypervisors, also called native or bare-metal hypervisors, run directly on the host physical machine and control the hardware devices.

Type-2 hypervisors, also known as hosted hypervisors, run on top of a host operating system, and thus do not typically control the hardware on the host machine directly.

Note that in both cases, the guest operating systems run on top of the hypervisor.

“Database.” This term has its ordinary and accepted meaning in the art, which includes a collection of records or data stored on a computer system.

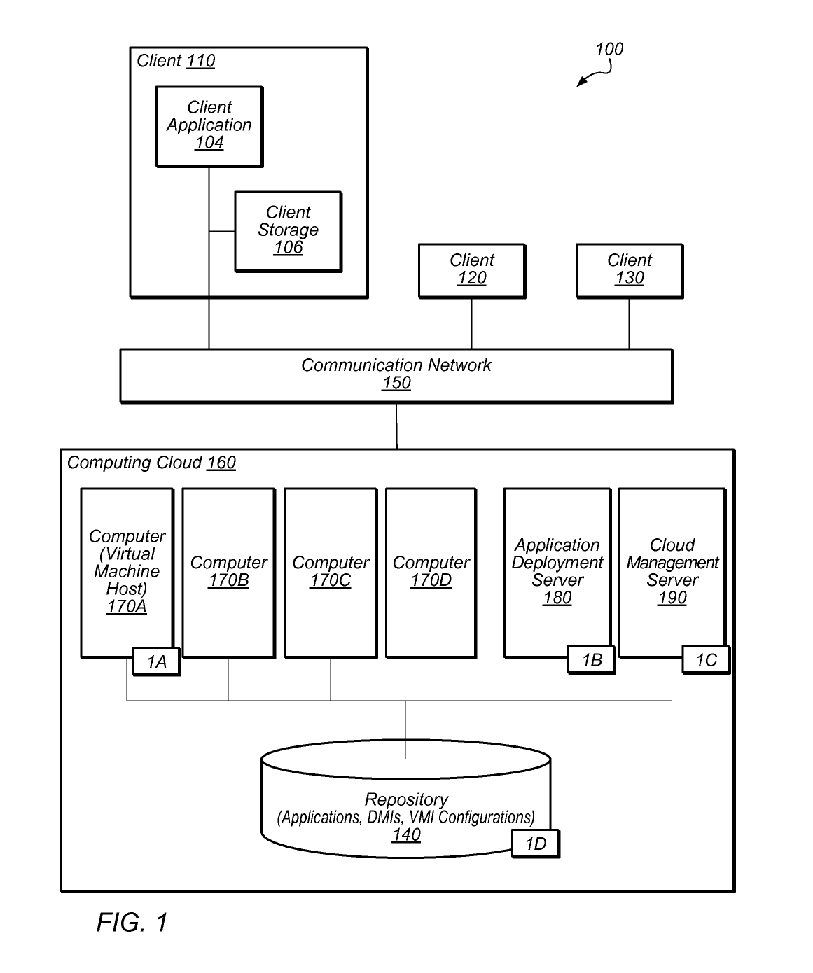

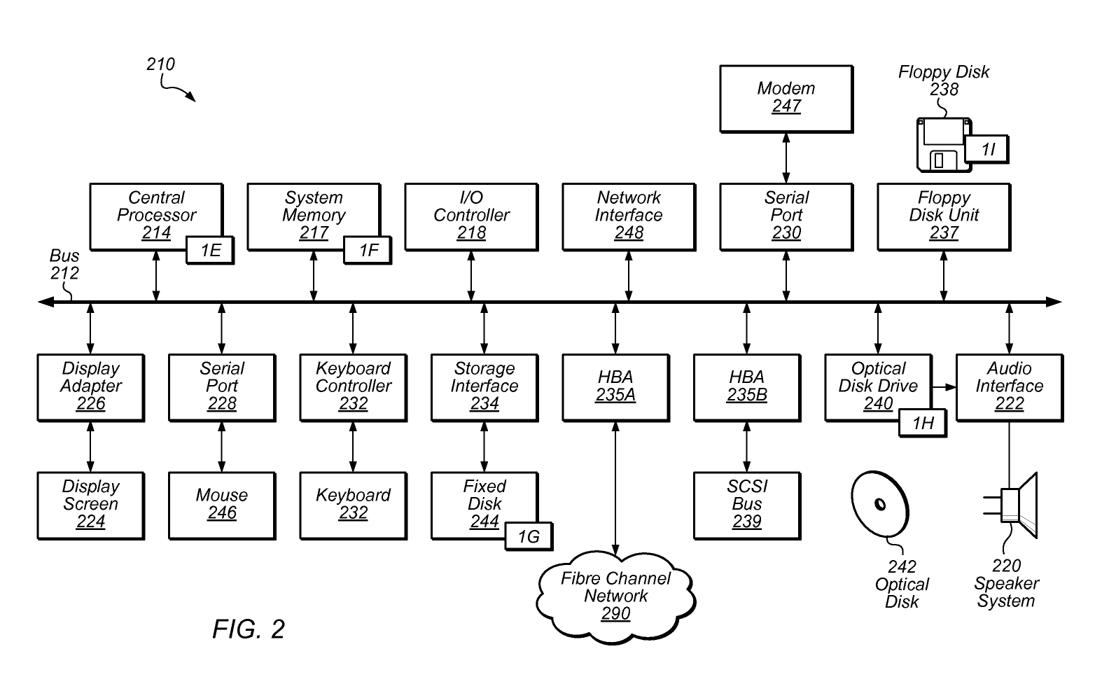

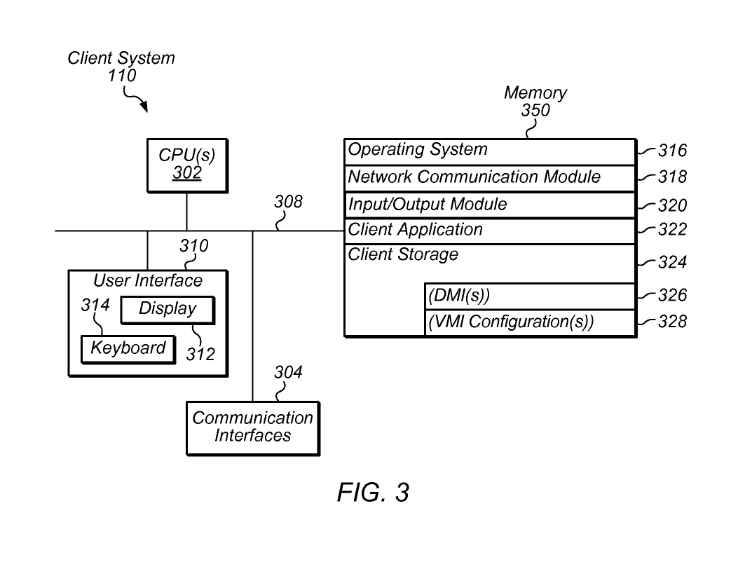

FIG. 1 is a block diagram depicting an exemplary network architecture 100 in which client systems 110, 120 and 130, (any of which may be implemented using computer system 210, shown in FIG. 2), are coupled to a communication network 150, which is coupled to or includes a computing cloud 160. Note that the number of clients shown is meant to be exemplary only, and is not intended to limit the number of clients to any particular number. As shown, the client computer 110 may include a client application 104, such as a web browser or other client software, e.g., a JAVA™ application, as well as client storage 106. Further details regarding an exemplary client computer system are provided below with reference to FIG. 3.

The computing cloud 160 includes a plurality of computers, e.g., server computers, and one or more storage devices, comprised in or coupled to the plurality of computers. For the sake of simplicity, the exemplary embodiment of FIG. 1 shows four cloud computing devices 170A-D. One (or more) of the cloud computing devices, e.g., computer 170A, may include a virtual machine instance, and thus may be referred to as a virtual machine host. However, it is noted that computing cloud 160 may typically comprise any number of computing resources, such as hundreds or even thousands of computer systems connected together.

The exemplary embodiment shown in FIG. 1 also may include an application deployment server 180, and a cloud management server 190, each coupled to a repository 140 (that may store applications, dynamic machine images, and/or virtual machine instance configurations, among others), each of which is described in detail below. The application deployment server 180, the cloud management server 190, the repository 140, and the virtual machine host 170A may be configured to implement embodiments of the disclosure as described herein, as indicated by exemplary elements 1A, 1B, 1C, and 1D, each of which may represent a respective portion of an implementation of the techniques disclosed herein, referred to as element 1. Thus, as described herein, software may be included which provides for dynamic deployment of applications to virtual machine instances. For example, in one embodiment, software (programs and/or data) may be provided in one or more components of the computing cloud 160, such as software implementing a virtual machine instance 1A in virtual host 170A, software implementing application delivery services 1B in application deployment server 180, software implementing cloud management services 1C in cloud management server 190, and/or software 1D comprising applications to be deployed, DMIs, and/or VMI configurations, etc., stored in repository 140.

However, it is noted that the functionalities disclosed herein regarding the computing cloud, e.g., provided by embodiments of element 1, may be implemented via one or more computers (e.g., servers) and one or more storage devices (which may or may not be comprised in one or more of the computers, and which may be in or outside the computing cloud),

It should be noted that as used herein, the term “storage medium” refers to one or more storage media (or mediums) that may be comprised in a single device, or may be distributed over multiple devices. Additionally, a storage medium may be comprised in a computer, e.g., a server computer system, or may be a simple networked storage device accessible by such computer systems. Thus, the repository 140 may be or include one or more storage servers, one or more simple storage devices coupled to the network, or may be comprised on one or more of the servers described herein, e.g., virtual machine host 170, application deployment server 180, or cloud management server 190.

Thus, while according to some embodiments one or more of the computers in the computing cloud, e.g., servers 170 (A, B, C, and/or D), 180, 190, may be configured to implement the present disclosure. However, as noted above, in various other embodiments, the functionalities described herein may be implemented on a single computer (server), or may be distributed over two or more computers in the cloud as desired.

As described further herein, embodiments of the invention may provide a more efficient mechanism for deploying virtual machine instances and associated applications.

With reference to computer system 210 of FIG. 2, modem 247, network interface 248 or some other method can be used to provide connectivity from each of client computer systems 110, 120 and 130 to network 150, and thus to the computing cloud 160. For example, client systems 110, 120 and 130 may be able to access cloud management server 190 using a client application 104, for example, a web browser or other client software, e.g., a JAVA™ application, as indicated above. While the system of FIG. 1 may be implemented via a Wide Area Network (WAN) such as the Internet, it should be noted that various other embodiments may be implemented via any type of network as desired.

FIG. 2 depicts a block diagram of an exemplary computer system 210 suitable for implementing embodiments of the present disclosure. As shown, computer system 210 includes a bus 212 which interconnects major subsystems of computer system 210, such as a central processor 214, a system memory 217 (typically RAM, but which may also include ROM, flash RAM, or the like), an input/output controller 218, an external audio device, such as a speaker system 220 via an audio output interface 222, an external device, such as a display screen 224 via display adapter 226, serial ports 228 and 230, a keyboard 232 (interfaced with a keyboard controller 233), a storage interface 234, a floppy disk drive 237 operative to receive a floppy disk 238, a host bus adapter (HBA) interface card 235A operative to connect with a Fibre Channel network 290, a host bus adapter (HBA) interface card 235B operative to connect to a SCSI bus 239, and an optical disk drive 240 operative to receive an optical disk 242. Also included are a mouse 246 (or other point-and-click device, coupled to bus 212 via serial port 228), a modem 247 (coupled to bus 212 via serial port 230), and a network interface 248 (coupled directly to bus 212). It should be noted, however, that the elements shown are meant to be exemplary only, and that one or more of the elements may be omitted as desired. Note further that the exemplary computer system 210 may represent a client computer, or a computer in the computing cloud (a server), with modifications regarding the elements shown as appropriate.

Bus 212 allows data communication between central processor 214 and system memory 217, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 210 are generally stored on and accessed via a computer readable medium, such as a hard disk drive (e.g., fixed disk 244), an optical drive (e.g., optical drive 240), a floppy disk unit 237, or other storage medium. Additionally, applications can be in the form of electronic signals modulated in accordance with the application and data communication technology when accessed via network modem 247 or interface 248.

Storage interface 234, as with the other storage interfaces of computer system 210, can connect to a standard computer readable medium for storage and/or retrieval of information, such as a fixed disk drive 244. Fixed disk drive 244 may be a part of computer system 210 or may be separate and accessed through other interface systems. Modem 247 may provide a direct connection to a remote server via a telephone link or to the Internet via an internet service provider (ISP). Network interface 248 may provide a direct connection to a remote server via a direct network link to the network, e.g., the Internet, via a POP (point of presence). Network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., tape drives, tape libraries, disk arrays, document scanners, digital cameras and so on). Conversely, all of the devices shown in FIG. 2 need not be present to practice the present disclosure. The devices and subsystems can be interconnected in different ways from that shown in FIG. 2. The operation of a computer system such as that shown in FIG. 2 is readily known in the art and is not discussed in detail in this application. Code to implement the present disclosure, referred to collectively as element 1, and portions of which are labeled with alphabetical suffixes (e.g., 1A . . . 1D) can be stored in computer-readable storage media such as one or more of system memory 217 (1F), fixed disk 244 (1G), optical disk 242 (1H), or floppy disk 238 (1I), and in some embodiments, a cache of the central processor 214 (1E). The operating system provided on computer system 210 may be MS-DOS®, MS-WINDOWS®, OS/2®, UNIX®, Linux®, or another known operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

FIG. 3 is a block diagram illustrating one exemplary embodiment of client (computer) system 110 (shown in FIG. 1) implementing the present disclosure. Although FIG. 3 represents one embodiment, it will be recognized that any number of variations thereof are also possible. Some of the components or modules are shown in parentheses to indicate that they are optional, e.g., may be implemented on or by other computers or cloud resources, e.g., computers and/or storage devices in the computing cloud.

Client system 110 typically includes one or more processing units (CPUs) 302, one or more network or other communications interfaces 304, memory 350, and one or more communication buses 308 for interconnecting these components. The client system 110 may optionally include a user interface 310, including a display 312 and a keyboard 314. The memory 350 may include high speed random access memory and may also include non-volatile memory, such as one or more magnetic or optical storage disks. The memory 350 may include mass storage that is remotely located from CPUs 302.

The memory 350 may store the following elements, or a subset or superset of such elements:

a) an operating system 316 that includes procedures for handling various basic system services and for performing hardware dependent tasks;

b) a network communication module (or instructions) 318 that is used for connecting the master server 190 to other computers via the one or more communications interfaces 304 (wired or wireless), such as the Internet, other wide area networks, local area networks, metropolitan area networks, and so on;

c) an input/output module 320, for sending and receiving input from other computers, e.g., from the computing cloud;

d) a client application 322, such as a web browser or other client software, e.g., a JAVA™ application, for communicating with the computing cloud; and/or

e) client storage 324 for (optionally) storing one or more dynamic machine images (DMIs) 325 and/or one or more VMI configurations 328.

It should be noted that in various embodiments, some or all of the modules above may be combined together or separated into further modules.

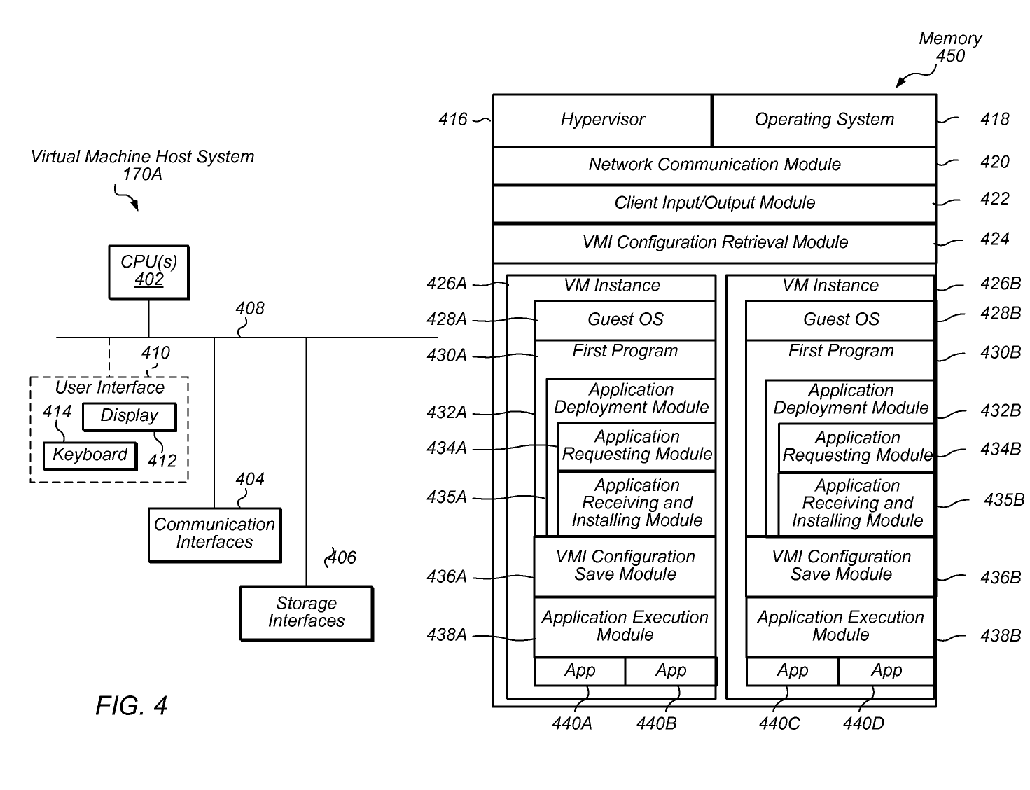

The following, directed to FIGS. 4, 5, and 6, describes embodiments wherein the functionalities disclosed herein are implemented via respective computers (servers) in the computing cloud, e.g., server computers 170A, 180, and 190 of FIG. 1, although it should be noted that the embodiments described are exemplary only, and are not intended to limit the implementations to any particular machine distribution or arrangement. In other words, in various embodiments, the functionalities described below with respect to these three exemplary computer systems may be implemented via (or distributed across) one or more computers and one or more storage media comprised in or coupled to the one or more computers. Similarly, various of the components or modules shown in these computer systems are shown in parentheses to indicate that they may be optional, e.g., may be implemented on or by other computers, e.g., computers in the computing cloud. Note that multiple copies or versions of a component or module that are distinguished via a capital letter suffix, e.g., modules 101A, 101B, etc., may be referred to collectively or generically via the number alone, e.g., module 101.

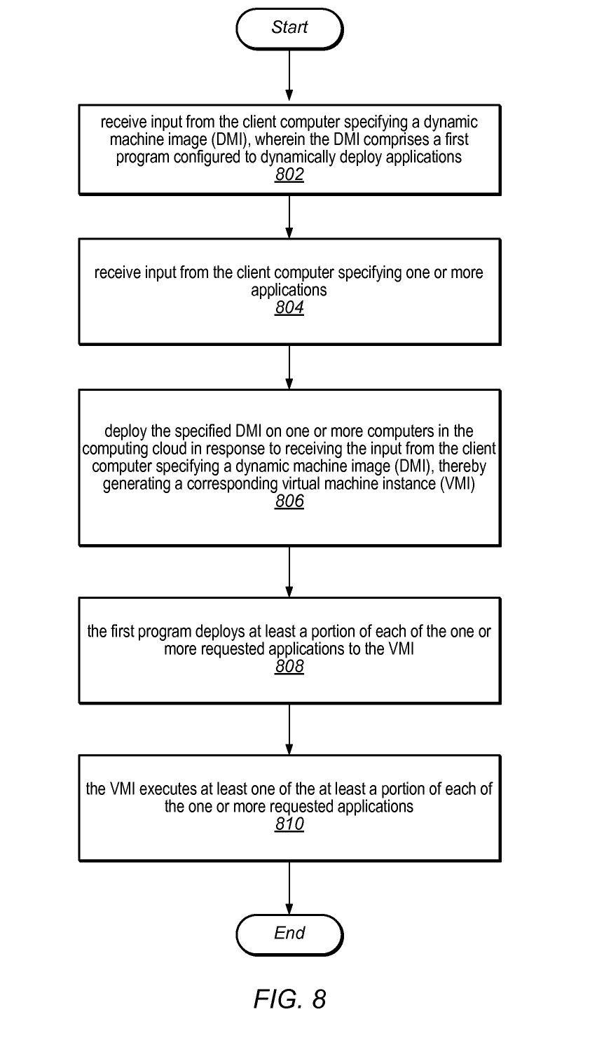

Further details regarding the functionality of these components or modules are provided below with respect to the method of FIG. 8.

FIG. 4 is a block diagram illustrating one embodiment of exemplary virtual machine host 170A (FIG. 1). Although FIG. 4 represents one embodiment, it will be recognized that any number of variations thereof are also possible.

The virtual machine host system 170A typically includes one or more processing units (CPUs) 402, one or more network or other communications interfaces 404, one or more storage interfaces 406, memory 450, and one or more communication buses 408 for interconnecting these components. The virtual machine host system 170A may optionally include a user interface 410, including a display 412 and a keyboard 414 (the optional nature of these components is indicated by dashed lines). The memory 450 may include high speed random access memory and may also include non-volatile memory, such as one or more magnetic or optical storage disks. The memory 450 may include mass storage that is remotely located from CPUs 402, accessible via the storage interface(s) 406. The memory 450 may store the following elements, or a subset or superset of such elements:

a) a hypervisor 416 (i.e., a virtualization module or virtual machine monitor) for implementing and managing virtual machines on the computer;

b) an operating system 418 that includes procedures for handling various basic system services and for performing hardware dependent tasks;

c) a network communication module (or instructions) 420 that is used for connecting the virtual machine host system 170A to other computers via the one or more communications interfaces 404 (wired or wireless), such as the Internet, other wide area networks, local area networks, metropolitan area networks, and so on;

d) a client input/output module 422 for receiving input from and sending output to client systems, e.g., for client interactions with the virtual machine instance (VMI) or applications executing thereon;

e) a VMI configuration retrieval module 424 for retrieving specified VMI configurations, e.g., from the repository, client system, another server, etc.; and

f) one or more virtual machine instances (VMIs) 426, e.g., 426A, 426B, etc., where each VMI may include one or more of:
1) a respective guest operating system 428, e.g., 428A, 428B, etc.;
2) a first program 430, e.g., 430A, 430B, etc., which may include:
   a) an application deployment module 432, e.g., 432A, 432B, etc., which itself may include one or more of:
      i) an application requesting module 434, e.g., 434A, 434B, etc.; or
      ii) an application receiving and installing module 435, e.g., 435A, 435B, etc.
3) a VMI configuration save module 436, e.g., 436A, 436B, etc.;
4) an application execution module 438, e.g., 438A, 438B, etc.; and
6) one or more respective applications 440, e.g., 440A/B, 440C/D, etc.

It should be noted that in various embodiments, some or all of the modules above may be combined together or separated into further modules.

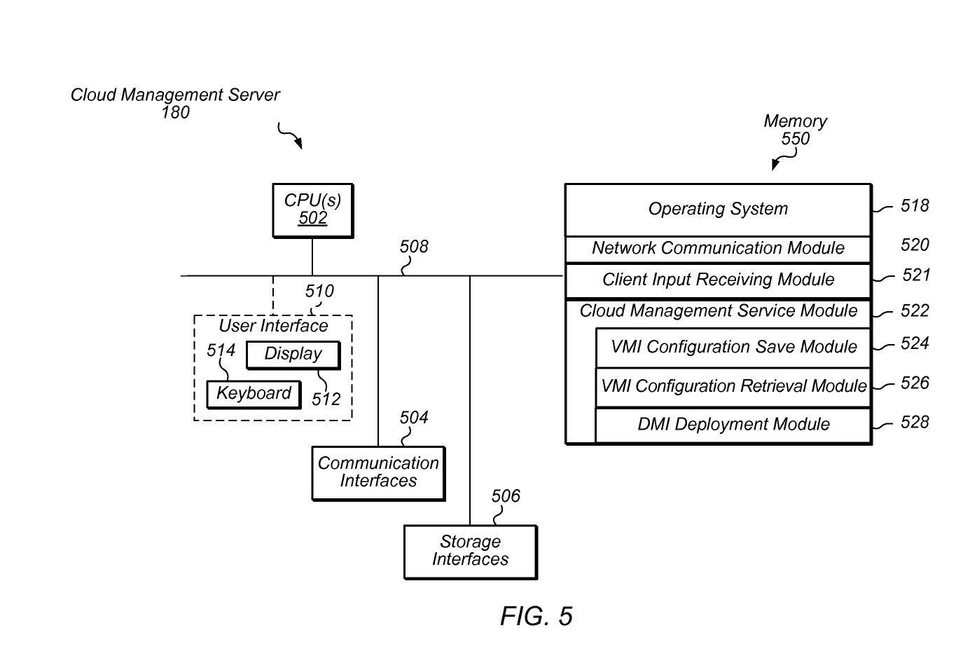

FIG. 5 is a block diagram illustrating one embodiment of a cloud management server 180, such as cloud management server 180 of FIG. 1. Although FIG. 5 represents one embodiment, it will be recognized that any number of variations thereof are also possible.

The cloud management server 180 typically includes one or more processing units (CPUs) 502, one or more network or other communications interfaces 504, one or more storage interfaces 506, memory 550, and one or more communication buses 508 for interconnecting these components. The cloud management server 180 may optionally include a user interface 510, including a display 512 and a keyboard 514 (the optional nature of these components is indicated by dashed lines). The memory 550 may include high speed random access memory and may also include non-volatile memory, such as one or more magnetic or optical storage disks. The memory 550 may include mass storage that is remotely located from CPUs 502, accessible via the storage interface(s) 506. The memory 550 may store the following elements, or a subset or superset of such elements:

a) an operating system 518 that includes procedures for handling various basic system services and for performing hardware dependent tasks;

b) a network communication module (or instructions) 520 that is used for connecting the cloud management server 180 to other computers via the one or more communications interfaces 504 (wired or wireless), such as the Internet, other wide area networks, local area networks, metropolitan area networks, and so on;

c) a client input receiving module 521 for receiving input from client systems; and

d) a cloud management service module 522, for communicating with client systems and instantiating VMIs, and which may further include one or more of:
1) a VMI configuration save module 524, for saving VMI configurations;
2) a VMI configuration retrieval module 526, for retrieving VMI configurations (e.g., for instantiation); or
3) a DMI deployment module 528, for deploying a DMI to implement a VMI on a computer system, e.g., on a virtual machine host system 170A.

It should be noted that in various embodiments, some or all of the modules above may be combined together or separated into further modules.

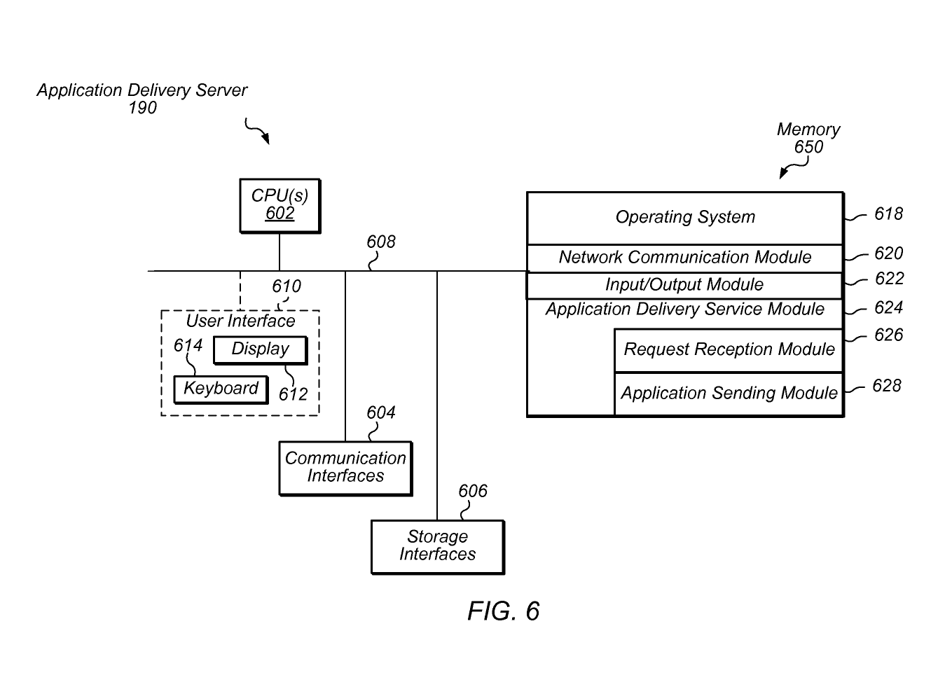

FIG. 6 is a block diagram illustrating one embodiment of an application delivery server 190, such as application delivery server 190 of FIG. 1. Although FIG. 6 represents one embodiment, it will be recognized that any number of variations thereof are also possible.

The application delivery server 190 typically includes one or more processing units (CPUs) 602, one or more network or other communications interfaces 604, one or more storage interfaces 606, memory 650, and one or more communication buses 608 for interconnecting these components. The application delivery server 190 may optionally include a user interface 610, including a display 612 and a keyboard 614 (the optional nature of these components is indicated by dashed lines). The memory 650 may include high speed random access memory and may also include non-volatile memory, such as one or more magnetic or optical storage disks. The memory 650 may include mass storage that is remotely located from CPUs 602, accessible via the storage interface(s) 606. The memory 650 may store the following elements, or a subset or superset of such elements:

a) an operating system 618 that includes procedures for handling various basic system services and for performing hardware dependent tasks;

b) a network communication module (or instructions) 620, for connecting the application delivery server 190 to other computers via the one or more communications interfaces 604 (wired or wireless), such as the Internet, other wide area networks, local area networks, metropolitan area networks, and so on;

c) an input/output module 622, for receiving input from and providing output to other computers and programs, e.g., the VMI or first program; and

d) an application delivery service module 624, for delivering applications dynamically to a VMI via a first program, which may further include one or more of:
1) a request reception module 626, for receiving requests for applications (or parts thereof) from first programs; or
2) an application sending module 628, for sending requested applications (or parts thereof) from a repository to the VMI for installation.

It should be noted that in various embodiments, some or all of the modules above may be combined together or separated into further modules.

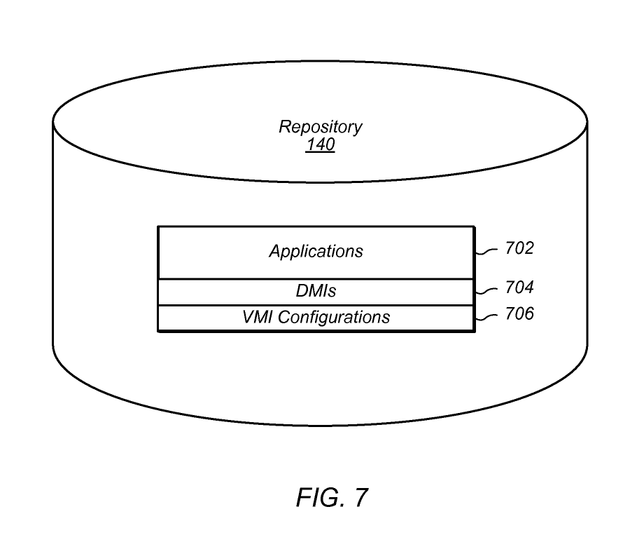

FIG. 7 is a block diagram illustrating one exemplary embodiment of repository 140 of FIG. 1. In various embodiments, the repository 140 may be implemented via one or more single simple storage mediums (media) or devices, via one or more storage servers, or some combination of the two. Moreover, the repository may include components that are included in the computing cloud and/or components external to, but coupled to, the computing cloud. For example, in one embodiment, the repository may be implemented or stored on the application delivery server 180.

As may be seen, the repository 140 may store applications 702, DMIs 704, and VMI configurations 706, among other items, although in various embodiments, the repository may store a subset or a superset of these items. For example, in some embodiments, the repository may also store client information, e.g., user created content, user specific customization, setup data, and other metadata; a browsable catalog of available applications, and so forth, as desired.

The applications, DMIs, and/or VMI configurations may be accessible to other computers in the computing cloud, e.g., the application delivery server, the first program executing on the virtual machine host system, etc., for downloading and deployment or installation.

It should be noted that the techniques disclosed herein enhance existing technologies such as application virtualization and application delivery technology, but are not limited to any specific implementation of application virtualization technology. Further, the techniques and functionalities described may be implemented as a proprietary service offered and operated in a cloud environment, and/or as a technology product sold and used by others, e.g., by a service provider.

Turning now to FIG. 8, a computer-implemented method is disclosed for application hosting on or in a computing cloud using dynamic machine images (DMIs). The method may be implemented by at least one computer system (e.g., one or more computers in the computing cloud shown in various of the previous Figures, e.g., servers 170A, 180, 190, or another computer system) and one or more storage devices (or media) included in or coupled to the at least one computer system. The (at least one) computer system may include, for example, one or more processors, and a computer readable storage medium which stores program instructions executable by the processor(s) to perform the method. The computer system may also include other hardware and/or components, for example, any of the hardware and components shown in and described with respect to FIG. 2. Another embodiment includes a computer readable storage medium (e.g., an article of manufacture) which stores program instructions executable to implement a method according to the embodiments described herein.

It should be noted that although the description below may set forth steps as being performed in a particular order, various of the steps may be performed in a different order, repeated, or omitted, as desired. One or more additional steps may also be performed, in some embodiments. The method may be performed as described below.

In 802, input from a client computer specifying a dynamic machine image (DMI) may be received. The DMI may include a software program (also referred to as a “first program”) which is configured to dynamically deploy applications. In some embodiments, the first program may be configured as an agent software program, and may be referred to as a dynamic application deployment (DAD) agent, although these labels are not intended to limit the first program to any particular implementation or functionality. In some embodiments, the input from the client computer may be received by a client input receiving module (e.g., program instructions for receiving client input), such as client input receiving module 521 shown in FIG. 5. For example, a user of the client computer system 110 may employ a web browser (or other suitable program) to log onto the cloud management server 190, and provide information specifying the DMI over the network. The cloud management server 190 may provide a graphical user interface (GUI) whereby the client user may interact with the cloud management server, e.g., to specify the DMI, e.g., allowing the user to browse available DMIs, e.g., corresponding to different operating systems (e.g., Windows™, Linux, MacOS™, etc.) and/or hardware configurations (32-bits, 64-bits, etc.), etc.

Note that the DMI may include the first program in any of various ways as desired. For example, in one embodiment, the DMI may physically contain the first program, i.e., may include the program instructions of the first program as part of itself. In other embodiments, the DMI may include the first program by reference, i.e., may include a reference to the first program, e.g., a pointer, URI (universal resource identifier), etc., whereby the first program may be accessed, executed, and so forth. In another embodiment, the DMI may include only a portion of the first program which may be executable to access or retrieve the remaining portion of the first program, e.g., from a storage medium in or coupled to the computing cloud. In a further embodiment, the DMI may include a second program which may be executable to access or retrieve the first program, e.g., from a storage medium.

In 804, input from the client computer specifying one or more applications may be received, e.g., via client input receiving module 521. For example, the client user may specify the application(s) via the web browser (or other program), e.g., by browsing and selecting from a catalog of available applications presented on a GUI.

In 806, the specified DMI may be deployed on or to one or more computers in the computing cloud in response to the above input from the client computer specifying a dynamic machine image (DMI), thereby generating a corresponding virtual machine instance (VMI). In some embodiments, this may be performed by a DMI deployment module (e.g., program instructions for deploying a DMI to implement a corresponding VMI, which may be executed by one or more processors), such as DMI deployment module 528 shown in FIG. 5.

In 808, the first program (e.g., the DAD agent) may deploy at least a portion of each of the requested applications to the VMI in response to the input from the client computer specifying the one or more applications, where the VMI is implemented on the one or more computers in the computing cloud. In some embodiments, this may be performed by a DMI deployment module (e.g., program instructions for deploying a DMI to implement a corresponding VMI, which may be executed by one or more processors), such as DMI deployment module 432 shown in FIG. 4. Note that the deployment of the DMI and application(s) may be performed in various ways, embodiments of which are described below.

In 810, at least one of the at least a portion of each of the one or more requested applications may be executed by the VMI. In other words, at least a portion of one of the deployed applications may be executed. In some embodiments, this may be performed by an application execution module (e.g., program instructions for executing applications installed on the VMI, which may be executed by one or more processors), such as application execution module 438 shown in FIG. 4.

Thus, one or more applications may be deployed dynamically to the VMI and executed. In some embodiments, the deployment and execution of a requested application may include dynamically streaming the application to the VMI as needed. In other words, portions of the requested application may be delivered (possibly substantially continuously) to the VMI as needed during execution of the application. In other embodiments, the application may be deployed and installed entirely prior to execution. During execution of the application(s), the user may interact with the executing application(s) over the network as if the application(s) were executing locally, i.e., on the client computer system. Note that in various embodiments, an application may start automatically upon deployment, or may do so in response to user input invoking execution of the application. Similarly, the user may terminate execution of a program via a command sent from the client computer system.

In one embodiment, the method may further include receiving input from the client computer specifying removal of at least one of the applications currently deployed to the VMI, or deployment of at least one additional application to the VMI. In response, the VMI may be dynamically modified, e.g., by uninstalling the at least one of the one or more applications from the VMI, or deploying at least a portion of the additional application(s) to the VMI, respectively. In other words, after the VMI has been implemented (by instantiating the DMI), the user may specify that one or more applications are to be added or removed from the VMI, and the specified applications may be uninstalled (if being removed), or deployed (if being added).

Said another way, after the initial deployment of the one or more applications to the VMI, the user may specify addition or removal of at least one application, in response to which the at least one application may be added or removed. Thus, the dynamic nature of the application deployment may extend to any number of subsequent operations, e.g., deploying or removing applications, as desired.

In some embodiments, a VMI configuration for the VMI may be saved in response to input from the client computer, where the VMI configuration specifies the DMI and the one or more applications. Thus, any changes made to the VMI (e.g., deployments or removals/uninstalls) after instantiation may be codified in a configuration file and saved to storage, e.g., on the client computer, a repository, or some other computer or storage device in or even external to the computing cloud. The VMI configuration may thus be useable to deploy the specified DMI and at least a portion of each of the one or more requested applications to the VMI, as discussed below. In some embodiments, the VMI configuration may include additional information as desired, e.g., configuration information for the applications, state information or data regarding the applications, e.g., for resuming execution after an interruption or termination of application execution, preferred or recommended hardware profiles for the VMI and/or applications, etc.

In one embodiment, the above input from the client computer specifying a dynamic machine image (DMI) and specifying one or more applications may comprise or compose a VMI configuration. The VMI configuration may specify the DMI and the one or more applications, thus, the specified DMI and applications (or portions thereof) may be instantiated/deployed based on the VMI configuration. In other words, the input from the client computer may specify the DMI and application(s) by specifying a VMI configuration, which may then be used to perform the instantiation of the DMI and/or deployment of the applications. In some embodiments, the VMI configuration may specify a DMI, but no applications, in which case, the client user may need to further specify the desired applications.

Note that the specified VMI configuration may be received or retrieved from any of various sources, e.g., from the client computer, from a storage device comprised in or coupled to the computing cloud, or from a repository comprised in or coupled to the computing cloud. In further embodiments, the VMI configuration may be received or retrieved from any other source as desired.

Note that the DMI (which is a pre-built software package) may already be present in the cloud (or in a storage device coupled to the cloud), or may be provided by the user. Thus, for example, in some embodiments, a user may provide (e.g., upload) the VMI configuration file to a server in the cloud (e.g., to the cloud management server) and rely on the server to retrieve the DMI, e.g., from local storage, from storage in the cloud, an external source, etc.), or the user may provide (upload) both the DMI and the VMI configuration file to the server, or the user may specify the exact location of both the configuration file and the DMI. Any other means for acquiring the DMI may be used as desired.

In one embodiment, the first program may deploy at least a portion of each of the one or more requested applications to the VMI by requesting the application(s) from an application delivery service. The VMI may then receive and install at least a portion of the requested application(s) from an application repository via the application delivery service in response to the requesting, thereby deploying the at least a portion of each of the one or more requested applications to the VMI. The application repository, e.g., repository 140, may be included in or coupled to the computing cloud, or may be external to the cloud.

Alternatively, or additionally, in some embodiments, the first program may deploy the at least a portion of each of the one or more requested applications to the VMI by retrieving and installing at least a portion of the requested application(s) directly from a storage device included in or coupled to the computing cloud, thereby deploying the at least a portion of (each of) the requested applications to the VMI. In further embodiments, the first program may receive or retrieve at least a portion of each of the requested applications from any other source or sources as desired, e.g., from the client computer, and may do so via the application delivery service, or directly.

Thus, in various embodiments, a catalog of applications, e.g., third-party applications, may be provided or made available to clients of the computing cloud, where the applications may be dynamically installed or “rented” by cloud users, requiring no prior installation process. Cloud users that want dynamic deployment of their own custom applications may store their applications in a central repository (or provide them directly), thus allowing cloud users to deploy and use their own applications in any combination dynamically, without having to maintain a plethora of pre-configured machine images.

In some embodiments, the first program may already be pre-installed in the machine images of supported OS versions, and may be the only custom (not “off the shelf”) software pre-installed in a dynamic machine image, where, as noted above, a machine image that includes the first program pre-installed implements a dynamic machine image, allowing on-the-fly customizations, as described above. Thus, a single dynamic machine image may alleviate or remove the need to maintain many (e.g., thousands of) different machine images by the service provider and the cloud users.

Thus, for example, in one specific exemplary embodiment of the above-described techniques, a cloud user may instantiate (or cause to be instantiated) a dynamic machine image of a desired operating system, e.g., made available by the service provider. Once the virtual machine instance is instantiated or booted, the cloud user may connect to the repository to select and deploy the applications desired, e.g., standard third-party applications, such as Microsoft Office™, or custom applications, e.g., stored by the cloud users in the repository. Once instantiated, an application may be installed dynamically, i.e., “on-the-fly”, using any of various application virtualization technologies, and streamed dynamically from the repository. The cloud user may then be able to customize and use the application(s) as if it were installed on the client's local disk. The applications installed by the cloud user and any subsequent customizations may be saved, e.g., in a folder, e.g., referred to as the “desktop” in one exemplary embodiment. All “desktops” may be stored for accessibility, e.g., in the repository, or some other storage device in or coupled to the computing cloud, and so in some embodiments, a cloud user may subsequently recall (and install) all previously installed applications, along with all the customizations, simply by logging into a previously created desktop. Moreover, in some embodiments, the cloud users may optionally use the computing cloud to store and access their own content. For example, in one exemplary embodiment, a storage server in the computing cloud (or some other server(s) or storage device(s) may provide a “My Documents” or equivalent folder to the cloud user, which may be automatically associated with the user's desktop. Thus, for example, a cloud user who has installed a word processing application may choose to store all his or her word processing documents in the “My Documents” folder on the storage server, which may be automatically available as part of the user's desktop.

In one embodiment, a cloud user may always access applications through the first program, e.g., the agent, enabling the first program to track and keep detailed records of application usage by the cloud users, which may be used by the service provider to charge the cloud user appropriately.

Thus, various embodiments may be used to minimize the number of customized machine images to be stored and maintained, and may enable efficient delivery and deployment of third-party and custom applications in cloud computing environments. For application hosting service providers, embodiments may enable dynamic delivery of third-party applications without having to provide thousands of static, pre-configured machine images for every possible use-case scenario, and for the cloud users, may obviate the need to maintain custom machine images, and may minimize or substantially reduce application specific state information to be stored in the cloud, thus further reducing storage and management costs.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A computer-implemented method for executing applications, comprising:
utilizing at least one computer in a computing cloud to perform:
receiving input from a client computer specifying a dynamic machine image (DMI), wherein the DMI comprises a first program configured to dynamically deploy applications;
receiving input from the client computer specifying one or more applications;
deploying the specified DMI on one or more computers in the computing cloud in response to said receiving input from the client computer specifying the DMI, thereby generating a corresponding virtual machine instance (VMI);
the first program deploying at least a portion of each of the one or more requested applications to the VMI in response to the input from the client computer specifying the one or more applications; and
the VMI executing at least one of the at least a portion of each of the one or more requested applications.

2. The computer-implemented method of claim 1, further comprising:
utilizing the at least one computer in a computing cloud to perform:
receiving input from the client computer specifying one or more of:
at least one of the one or more applications to be removed from the VMI; or
at least one additional application to be deployed to the VMI; and
dynamically modifying the VMI in response to said receiving input, comprising one or more of:
uninstalling the at least one of the one or more applications from the VMI in response to the user input from the client computer specifying at least one of the one or more applications to be removed from the VMI; or
deploying at least a portion of the at least one additional application to the VMI in response to the input from the client computer specifying at least one additional application to be deployed to the VMI.

3. The computer-implemented method of claim 1, further comprising:
utilizing the at least one computer to perform:
saving a VMI configuration for the VMI in response to input from the client computer, wherein the VMI configuration specifies the DMI and the one or more applications, and wherein the VMI configuration is useable to deploy the specified DMI and deploy the at least a portion of each of the one or more requested applications to the VMI.

4. The computer-implemented method of claim 1, wherein said receiving input from the client computer specifying a dynamic machine image (DMI) and said receiving input from the client computer specifying one or more applications composes:
receiving input from the client computer specifying a VMI configuration, wherein the VMI configuration specifies the DMI and the one or more applications, and wherein said deploying the specified DMI and said first program deploying the at least a portion of each of the one or more requested applications comprise:
receiving the specified VMI configuration; and
performing said deploying the specified DMI and said first program deploying the at least a portion of each of the one or more requested applications based on the VMI configuration.

5. The computer-implemented method of claim 4, wherein said receiving the specified VMI configuration comprises one or more of:
receiving the specified VMI configuration from the client computer;
retrieving the specified VMI configuration from a storage device comprised in or coupled to the computing cloud; or
retrieving the specified VMI configuration from a repository comprised in or coupled to the computing cloud.

6. The computer-implemented method of claim 1, wherein said first program deploying at least a portion of each of the one or more requested applications to the VMI comprises:
the first program requesting the one or more applications from an application delivery service; and
the VMI receiving and installing at least a portion of each of the one or more requested applications from an application repository via the application delivery service in response to said requesting, thereby deploying the at least a portion of each of the one or more requested applications to the VMI, wherein the application repository is comprised in or coupled to the computing cloud.

7. The computer-implemented method of claim 1, wherein said first program deploying at least a portion of each of the one or more requested applications to the VMI comprises:
the first program retrieving and installing at least a portion of each of the one or more requested applications directly from a storage device comprised in or coupled to the computing cloud, thereby deploying the at least a portion of each of the one or more requested applications to the VMI.

8. A computer readable storage medium storing program instructions executable by at least one computer in a computing cloud to:
receive input from the client computer specifying a dynamic machine image (DMI), wherein the DMI comprises a first program configured to dynamically deploy applications;
receive input from the client computer specifying one or more applications;
deploy the specified DMI on one or more computers in the computing cloud in response to said receiving input from the client computer specifying a dynamic machine image (DMI), thereby generating a corresponding virtual machine instance (VMI);
wherein the deployed first program is executable by the one or more computers in the computing cloud to deploy at least a portion of each of the one or more requested applications to the VMI in response to the input from the client computer specifying the one or more applications; and
wherein the deployed VMI is executable by the one or more computers in the computing cloud to execute at least one of the at least a portion of each of the one or more requested applications.

9. The computer readable storage medium of claim 8, wherein the program instructions are further executable by the at least one computer in the computing cloud to:
receive input from the client computer specifying one or more of:
at least one of the one or more applications to be removed from the VMI; or
at least one additional application to be deployed to the VMI; and
dynamically modify the VMI in response to said receiving input, comprising one or more of:
uninstalling the at least one of the one or more applications from the VMI in response to the user input from the client computer specifying at least one of the one or more applications to be removed from the VMI; or
deploying at least a portion of the at least one additional application to the VMI in response to the input from the client computer specifying at least one additional application to be deployed to the VMI.

10. The computer readable storage medium of claim 8, wherein the program instructions are further executable by the at least one computer in the computing cloud to:
save a VMI configuration for the VMI in response to input from the client computer, wherein the VMI configuration specifies the DMI and the one or more applications, and wherein the VMI configuration is useable to deploy the specified DMI and deploy the at least a portion of each of the one or more requested applications to the VMI.

11. The computer readable storage medium of claim 8, wherein to receive input from the client computer specifying a dynamic machine image (DMI) and to receive input from the client computer specifying one or more applications, the program instructions are further executable by the at least one computer in the computing cloud to:
receive input from the client computer specifying a VMI configuration, wherein the VMI configuration specifies the DMI and the one or more applications;
wherein to deploy the specified DMI, the program instructions are further executable by the at least one computer in the computing cloud to:
receive the specified VMI configuration; and
deploy the specified DMI based on the VMI configuration, including deploying the first program; and
wherein the first program deploys the at least a portion of each of the one or more requested applications based on the VMI configuration.

12. The computer readable storage medium of claim 11, wherein to receive the specified VMI configuration, the program instructions are executable by the at least one computer in the computing cloud to:
receive the specified VMI configuration from the client computer;
retrieve the specified VMI configuration from a storage device comprised in or coupled to the computing cloud; or
retrieve the specified VMI configuration from a repository comprised in or coupled to the computing cloud.

13. The computer readable storage medium of claim 8,
wherein to deploy at least a portion of each of the one or more requested applications to the VMI, the first program is executable by the one or more computers in the computing cloud to:
request the one or more applications from an application delivery service; and
wherein the VMI is executable by the one or more computers in the computing cloud to:
receive and install at least a portion of each of the one or more requested applications from an application repository via the application delivery service in response to the request, thereby deploying the at least a portion of each of the one or more requested applications to the VMI, wherein the application repository is comprised in or coupled to the computing cloud.

14. The computer readable storage medium of claim 8, wherein to deploy at least a portion of each of the one or more requested applications to the VMI, the first program is executable by the one or more computers in the computing cloud to:
retrieve and install at least a portion of each of the one or more requested applications from a storage device comprised in or coupled to the computing cloud, thereby deploying the at least a portion of each of the one or more requested applications to the VMI

15. A system, comprising:
at least one computer comprised in a computing cloud; and
one or more storage devices coupled to the at least one computer;
wherein the at least one computer comprises:
a processor; and
a computer-readable storage medium, coupled to the processor, wherein the computer-readable storage medium stores program instructions executable by the processor to:
receive input from the client computer specifying a dynamic machine image (DMI), wherein the DMI comprises a first program configured to dynamically deploy applications;
receive input from the client computer specifying one or more applications;
deploy the specified DMI on one or more computers in the computing cloud in response to said receiving input from the client computer specifying a dynamic machine image (DMI), thereby generating a corresponding virtual machine instance (VMI);
wherein the deployed first program is executable by the one or more computers in the computing cloud to deploy at least a portion of each of the one or more requested applications to the VMI in response to said receiving input from the client computer specifying one or more applications; and
wherein the deployed VMI is executable by the one or more computers in the computing cloud to execute at least one of the at least a portion of each of the one or more requested applications.

16. The system of claim 15, wherein the program instructions are further executable by the at least one computer in the computing cloud to:
receive input from the client computer specifying one or more of:
at least one of the one or more applications to be removed from the VMI; or
at least one additional application to be deployed to the VMI;
dynamically modify the VMI in response to said receiving input, comprising one or more of:
uninstalling the at least one of the one or more applications from the VMI in response to the user input from the client computer specifying at least one of the one or more applications to be removed from the VMI; or
deploying at least a portion of the at least one additional application to the VMI in response to the input from the client computer specifying at least one additional application to be deployed to the VMI.

17. The system of claim 15, wherein the program instructions are further executable by the at least one computer in the computing cloud to:
save a VMI configuration for the VMI in response to input from the client computer, wherein the VMI configuration specifies the DMI and the one or more applications, and wherein the VMI configuration is useable to deploy the specified DMI and deploy the at least a portion of each of the one or more requested applications to the VMI.

18. The system of claim 15, wherein to receive input from the client computer specifying a dynamic machine image (DMI) and to receive input from the client computer specifying one or more applications, the program instructions are further executable by the at least one computer in the computing cloud to:
receive input from the client computer specifying a VMI configuration, wherein the VMI configuration specifies the DMI and the one or more applications;
wherein to deploy the specified DMI, the program instructions are further executable by the at least one computer in the computing cloud to:
receive the specified VMI configuration; and
deploy the specified DMI based on the VMI configuration, including deploying the first program; and
wherein the first program deploys the at least a portion of each of the one or more requested applications based on the VMI configuration; and
wherein to receive the specified VMI configuration, the program instructions are executable by the at least one computer in the computing cloud to:
receive the specified VMI configuration from the client computer;
retrieve the specified VMI configuration from a storage device comprised in or coupled to the computing cloud; or
retrieve the specified VMI configuration from a repository comprised in or coupled to the computing cloud.

19. The system of claim 15,
wherein to deploy at least a portion of each of the one or more requested applications to the VMI, the first program is executable by the one or more computers in the computing cloud to:
request the one or more applications from an application delivery service; and
wherein the VMI is executable by the one or more computers in the computing cloud to:
receive and install at least a portion of each of the one or more requested applications from an application repository via the application delivery service in response to the request, thereby deploying the at least a portion of each of the one or more requested applications to the VMI, wherein the application repository is comprised in or coupled to the computing cloud.

20. The system of claim 15, wherein to deploy at least a portion of each of the one or more requested applications to the VMI, the first program is executable by the one or more computers in the computing cloud to:
retrieve and install at least a portion of each of the one or more requested applications from a storage device comprised in or coupled to the computing cloud, thereby deploying the at least a portion of each of the one or more requested applications to the VMI

21. A computer-implemented method for executing applications, comprising:
utilizing at least one computer in a computing cloud to perform:
a first program configured to dynamically deploy applications deploying at least a portion of each of one or more applications to a virtual machine instance (VMI), wherein the VMI comprises the first program, wherein the VMI was instantiated from a dynamic machine image (DMI) that comprises the first program, wherein the VMI is implemented on the at least one computer in the computing cloud, and wherein the DMI and the one or more applications were specified by input received from a client computer; and
the VMI executing at least one of the at least a portion of each of the one or more requested applications.

22. The computer-implemented method of claim 21, further comprising:
utilizing the at least one computer in a computing cloud to perform:
receiving input from the client computer specifying one or more of:
at least one of the one or more applications to be removed from the VMI; or
at least one additional application to be deployed to the VMI; and
dynamically modifying the VMI in response to said receiving input, comprising one or more of:
uninstalling the at least one of the one or more applications from the VMI in response to the user input from the client computer specifying at least one of the one or more applications to be removed from the VMI; or
deploying at least a portion of the at least one additional application to the VMI in response to the input from the client computer specifying at least one additional application to be deployed to the VMI.

23. The computer-implemented method of claim 21, further comprising:
utilizing the at least one computer to perform:
saving a VMI configuration for the VMI in response to input from the client computer, wherein the VMI configuration specifies the DMI and the one or more applications, and wherein the VMI configuration is useable to deploy the specified DMI and deploy the at least a portion of each of the one or more specified applications to the VMI.

24. The computer-implemented method of claim 21, wherein said first program deploying at least a portion of each of the one or more requested applications to the VMI comprises:
the first program requesting the one or more applications from an application delivery service; and
the VMI receiving and installing at least a portion of each of the one or more requested applications from an application repository via the application delivery service in response to said requesting, thereby deploying the at least a portion of each of the one or more requested applications to the VMI, wherein the application repository is comprised in or coupled to the computing cloud.

25. The computer-implemented method of claim 21, wherein said first program deploying at least a portion of each of the one or more requested applications to the VMI comprises:
the first program retrieving and installing at least a portion of each of the one or more requested applications directly from a storage device comprised in or coupled to the computing cloud, thereby deploying the at least a portion of each of the one or more requested applications to the VMI.

26. A computer readable storage medium storing program instructions executable by at least one computer in a computing cloud to:
deploy, via a first program configured to dynamically deploy applications, at least a portion of each of one or more applications to a virtual machine instance (VMI), wherein the VMI comprises the first program, wherein the VMI was instantiated from a dynamic machine image (DMI) that comprises the first program, wherein the VMI is implemented on the at least one computer in the computing cloud, and wherein the DMI and the one or more applications were specified by input received from a client computer; and
execute, via the VMI, at least one of the at least a portion of each of the one or more requested applications.

27. The computer readable storage medium of claim 26, wherein the program instructions are further executable by the at least one computer in the computing cloud to:
receiving input from the client computer specifying one or more of:
at least one of the one or more applications to be removed from the VMI; or
at least one additional application to be deployed to the VMI; and
dynamically modifying the VMI in response to said receiving input, comprising one or more of:
uninstalling the at least one of the one or more applications from the VMI in response to the user input from the client computer specifying at least one of the one or more applications to be removed from the VMI; or
deploying at least a portion of the at least one additional application to the VMI in response to the input from the client computer specifying at least one additional application to be deployed to the VMI.

28. The computer readable storage medium of claim 26, wherein the program instructions are further executable by the at least one computer in the computing cloud to:
save a VMI configuration for the VMI in response to input from the client computer, wherein the VMI configuration specifies the DMI and the one or more applications, and wherein the VMI configuration is useable to deploy the specified DMI and deploy the at least a portion of each of the one or more specified applications to the VMI.

29. The computer readable storage medium of claim 26, wherein to deploy the at least a portion of each of the one or more requested applications to the VMI, the program instructions are further executable by the at least one computer in the computing cloud to:
request, via the first program, the one or more applications from an application delivery service; and
receive and install, via the VMI, the at least a portion of each of the one or more requested applications from an application repository via the application delivery service in response to said requesting, thereby deploying the at least a portion of each of the one or more requested applications to the VMI, wherein the application repository is comprised in or coupled to the computing cloud.

30. The computer readable storage medium of claim 26, wherein to deploy the at least a portion of each of the one or more requested applications to the VMI, the program instructions are further executable by the at least one computer in the computing cloud to:
receive and install, the first program, the at least a portion of each of the one or more requested applications directly from a storage device comprised in or coupled to the computing cloud, thereby deploying the at least a portion of each of the one or more requested applications to the VMI.
